(19) United States
(12) Patent Application Publication
(10) Pub. No.: US 2015/0195404 A1
(43) Pub. Date: Jul. 9, 2015

(54) SYSTEMS AND METHODS OF MANAGING COMPETING BUSINESS GOALS OF A CONTACT CENTER

(71) Applicant: Avaya Inc., Basking Ridge, NJ (US)

(72) Inventors: Neil O'Connor, Galway (IE); Tony McCormack, Galway (IE); James Bourke, Co. Mayo (IE); Sean Corcoran, Co. Galway (IE)

(73) Assignee: Avaya Inc., Basking Ridge, NJ (US)

(21) Appl. No.: 14/149,182

(22) Filed: Jan. 7, 2014

(51) Int. Cl. H04M 3/51; G06F 3/0484; G06F 3/0486; G06Q 10/06; G06Q 40/00

(52) U.S. Cl. CPC H04M 3/5175; G06Q 10/0637; G06Q 40/00; G06F 3/0486; G06F 3/04842

(57) ABSTRACT

An optimization system for generating a visual representation of business goals in a contact center is disclosed. The optimization system includes a monitor module configured to monitor current status of the business goals of the contact center. The optimization system further includes a computing module configured to compute values of the business goals and generate the visual representation. The optimization system further includes a drag module configured to enable a user to change value of a business goal from an actual operating value to a desired operating value. The optimization system further includes a display module configured to display modification in values of associated business goals due to the change in the value of the business goal.

### BACKGROUND

1. Field of the Invention

Embodiments of the present invention generally relate to a system and method for managing business goals of a contact center, and particularly to a system and method for generating a visual representation of competing business goals.

2. Description of Related Art

Contact centers are employed by many enterprises to service inbound and outbound contacts from customers. A typical contact center includes a switch and/or server to receive and route incoming packet-switched and/or circuit-switched contacts and one or more resources, such as human agents and automated resources (e.g., Interactive Voice Response units (IVR)), to service the incoming contacts. Contact centers distribute contacts, whether inbound or outbound, for servicing to any suitable resource according to predefined criteria. In many existing systems, the criteria for servicing the contact from the moment that the contact center becomes aware of the contact until the contact is connected to an agent are client or operator-specifiable (i.e., programmable by the operator of the contact center), via a capability called vectoring. Normally in present-day Automatic Call Distributions (ACDs) when the ACD system's agent assisting system detects that an agent has become available to handle a contact, the agent assisting system identifies all predefined contact-handling queues for the agent (usually in some order of priority) and delivers to the agent the highest-priority, oldest contact that matches the agent's highest-priority queue. Generally, the only condition that results in a contact not being delivered to an available agent is that there are no contacts waiting to be handled.

The primary objective of contact center management is to ultimately maximize contact center performance and profitability. An ongoing challenge in contact center administration is monitoring and optimizing contact center efficiency. The contact center efficiency is generally measured in two ways that are service level and match rate.

Service level is one measurement of the contact center efficiency. Service level is typically determined by dividing the number of contacts accepted within the specified period by the number accepted plus the number that were not accepted, but completed in some other way (e.g., abandoned, given busy, canceled, flowed out). Of course, service level definitions may vary from one enterprise to another.

Match rate is another indicator used in measuring contact center efficiency. Match rate is usually determined by dividing the number of contacts accepted by a primary skill level agent within a period of time by the number of contacts accepted by any agent for a queue over the same period. An agent with a primary skill level is one that typically can handle contacts of a certain nature most effectively and/or efficiently. There are other contact center agents that may not be as proficient as the primary skill level agent, and those agents are identified either as secondary skill level agents or backup skill level agents. As can be appreciated, contacts received by a primary skill level agent are typically handled more quickly and accurately or effectively (e.g., higher revenue attained) than a contact received by a secondary or even backup skill level agent. Thus, it is an objective of most contact centers to optimize match rate along with service level.

In addition to service level and match rate performance measures, contact centers use other Key Performance Indicators (“KPIs”), such as revenue, estimated, actual, or predicted wait time, average speed of answer, throughput, agent utilization, agent performance, agent responsiveness and the like, to calculate performance relative to their Service Level Agreements (“SLAs”). Operational efficiency is achieved when KPIs are managed near, but not above, SLA levels.

Throughput is a measure of the number of calls/contact requests or work requests that can be processed in a given amount of time. Agent utilization is a measure of how efficiently agents' time is being used. Customer service level is a measure of the time customers spend waiting for their work to be handled. Company contact center customers wish to provide service to as many requests as possible in a given amount of time, using the least number of agents to do so, and minimizing the wait time for their customers that can increase the service level agreement of the contact center.

Generally, managers (e.g., supervisors or administrators) of a contact center face a major challenge in meeting the objectives of their business while being constrained by the resources at their disposal. Sometimes, measures taken by the supervisor of the contact center to achieve these business goals may have adverse effects on other competing business goals of the contact center. For example, if the objective of the contact center is to increase average revenue, then the impact of changing value of the average revenue on other competing business goals are not determined by the supervisor of the contact center. Further, conventional techniques have the ability to manage a single business goal such as service objective at a time. For example, while maintaining the service objective, all incoming calls are considered at a same priority, as the priority and service objectives are two different goals. To further complicate the matters, often there are more than one business objectives or goals that must be met, and these objectives must compete for the same resources. Also, due to these competing goals and the unpredictable nature of the incoming demands on the customer portal of the business, the supervisor of the contact center try to manage two or more business objectives simultaneously, it often ends up having to make trade-offs and compromises in real time.

Further, when selecting and configuring applications of the contact center, the supervisor configure agent's skills, business objectives, reserve agents, call distributors, thresholds etc. This is done by using best estimates of expected traffic volume in the contact center. However, compromise or change in value of one business goal may affect the performances on other business goals.

There is thus a need for a system and method to manage the competing business goals of the contact center.

### SUMMARY

Embodiments in accordance with the present invention further provide an optimization system for generating a visual representation of business goals in a contact center. The optimization system includes a monitor module configured to monitor current status of the business goals of the contact center. The optimization system further includes a computing module configured to compute values of the business goals and generate the visual representation. The optimization system further includes a drag module configured to enable a user to change value of a business goal from an actual operating value to a desired operating value. The optimization system further includes a display module configured to display modification in values of associated business goals due to the change in the value of the business goal.

Embodiments in accordance with the present invention further provide a computer-implemented method for generating a visual representation of business goals in a contact center. The computer-implemented method includes monitoring current status of the business goals of the contact center, computing values for the business goals of the contact center based on the monitored status of the business goals, generating the visual representation of the business goals based on the computed values, enabling a user to change value of a business goal from an actual operating value to a desired operating value in the visual representation, and displaying modification in values of associated business goals due to the change in the value of the business goal.

Embodiments in accordance with the present invention further provide a computer-implemented method for generating a visual representation of desired business goals in a contact center. The computer-implemented method includes monitoring current status of the business goals of the contact center, computing values for the business goals of the contact center based on the monitored status of the business goals, generating the visual representation of the business goals based on the computed values, receiving a user input for a desired value of a business goal of the contact center, computing modification in values of associated business goals of the contact center based on the received input, generating a modified visual representation of the business goal and associated business goals based on the modified values of the competing business goals, and displaying the modified values of the business goal and associated business goals in the generated modified visual representation.

The present invention can provide a number of advantages depending on its particular configuration. First, the present invention provides a visual representation of business goals in a human consumable way (e.g., pie charts, bar graphs, histograms etc.) that helps the supervisor of the contact center to assist in effectively manipulating and managing resources without compromising business goals of the contact center. Next, the present invention provides a visual tool to first optimize the values of the business goals and then see the impact of such values on other competing business goals. Also, the present invention allows the supervisor of the contact center to monitor current status of the business goals that may result from existing routing strategy of work assignment based contact center.

Further, the present invention provides a holistic approach to the management of the contact center. The present invention provides managing attribute based routing to uniquely identify resources at an agent-granularity level. Also, the present invention provides an ability to notify a user and react to an under target business goal such as service level agreement performance. The present invention provides the supervisor an ability to simply drag the outline of the service level agreement outwards and the present invention provides solutions (e.g., priority increase on routing) that may results in improving a score of the service level agreement. Also, the present invention can be made available to the supervisor of the contact center through a web portal that is integrated with an administration tool. The present invention may update parameters of the work assignment's underlying routing strategy due to manipulation of the visual representation. Further, the present invention provides a supervisor or manager an effective means of fine-tuning the strategy's governing parameters. Furthermore, the present invention provides the visual feedback to the supervisor for a desired modification in a business goal and associated business goals.

These and other advantages will be apparent from the disclosure of the present invention(s) contained herein.

The preceding is a simplified summary of the present invention to provide an understanding of some aspects of the present invention. This summary is neither an extensive nor exhaustive overview of the present invention and its various embodiments. It is intended neither to identify key or critical elements of the present invention nor to delineate the scope of the present invention but to present selected concepts of the present invention in a simplified form as an introduction to the more detailed description presented below. As will be appreciated, other embodiments of the present invention are possible utilizing, alone or in combination, one or more of the features set forth above or described in detail below.

### BRIEF DESCRIPTION OF THE DRAWINGS

The above and still further features and advantages of the present invention will become apparent upon consideration of the following detailed description of embodiments thereof, especially when taken in conjunction with the accompanying drawings, and wherein:

FIG. 1 illustrates a block diagram depicting a contact center according to an embodiment of the present invention;

FIG. 2 illustrates a block diagram of a server according to an embodiment of the present invention;

FIGS. 3A and 3B depict a flowchart of a method for generating a visual representation of business goals according to an embodiment of the present invention;

FIG. 4 illustrates a visual representation of monitored values of business goals according to an embodiment of the present; and

FIG. 5 illustrates a visual representation of modification in competing business goals due to change in value of one business goal according to an embodiment of the present.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures. Optional portions of the figures may be illustrated using dashed or dotted lines, unless the context of usage indicates otherwise.

### DETAILED DESCRIPTION

The present invention will be illustrated below in conjunction with an exemplary communication system, e.g., the Avaya Aura® system. Although well suited for use with, e.g., a system having an Automatic Call Distribution (ACD) or other similar contact processing switch, the present invention is not limited to any particular type of communication system switch or configuration of system elements. Those skilled in the art will recognize the disclosed techniques may be used in any communication application in which it is desirable to provide improved contact processing.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read.

A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the present invention is considered to include a tangible storage medium or distribution medium and prior art-recognized equivalents and successor media, in which the software implementations of the present invention are stored.

The terms “determine”, “calculate” and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the present invention is described in terms of exemplary embodiments, it should be appreciated those individual aspects of the present invention can be separately claimed.

The term “switch” or “server” as used herein should be understood to include a Private Branch Exchange (PBX), an ACD, an enterprise switch, or other type of communications system switch or server, as well as other types of processor-based communication control devices such as media servers, computers, adjuncts, etc.

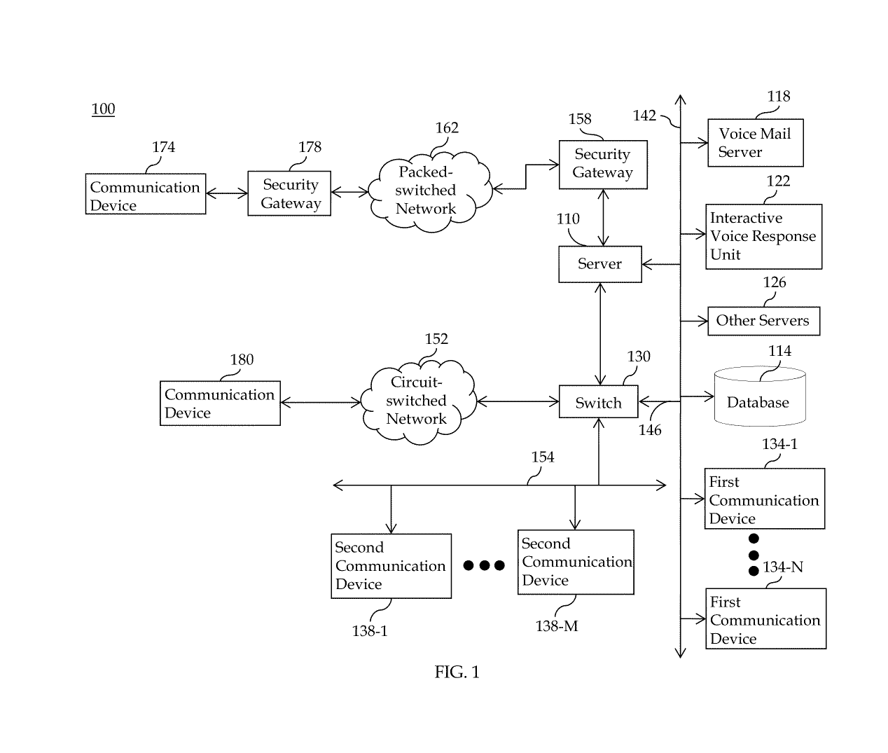

FIG. 1 shows an illustrative embodiment of the present invention. A contact center 100 comprises a server 110, a set of data stores or databases 114 containing contact or customer related information and other information that may enhance the value and efficiency of the contact processing, and a plurality of servers, namely a voice mail server 118, an Interactive Voice Response unit (e.g., IVR) 122, and other servers 126, a switch 130, a plurality of working agents operating packet-switched (first) communication devices 134-1-N (such as computer work stations or personal computers), and/or circuit-switched (second) communication devices 138-1-M, all interconnected by a Local Area Network (LAN) 142, (or Wide Area Network (WAN)). The servers may be connected via optional communication lines 146 to the switch 130. As will be appreciated, the other servers 126 may also include a scanner (which is normally not connected to the switch 130 or Web Server), VoIP software, video call software, voice messaging software, an IP voice server, a fax server, a web server, an email server, and the like. The switch 130 is connected via a plurality of trunks to a circuit-switched network 152 (e.g., Public Switch Telephone Network (PSTN)) and via link(s) 154 to the second communication devices 138-1-M. A security gateway 158 is positioned between the server 110 and a packet-switched network 162 to process communications passing between the server 110 and the packet-switched network 162. The security gateway 158 may be implemented as hardware such as via an adjunct processor (as shown) or as a chip in the server.

Although the preferred embodiment is discussed with reference to client-server architecture, it is to be understood that the principles of the present invention apply to other network architectures. For example, the present invention applies to peer-to-peer networks, such as those envisioned by the Session Initiation Protocol (SIP). In the client-server model or paradigm, network services and the programs used by end users to access the services are described. The client side provides a user with an interface for requesting services from the network, and the server side is responsible for accepting user requests for services and providing the services transparent to the user. By contrast in the peer-to-peer model or paradigm, each networked host runs both the client and server parts of an application program. Additionally, the present invention does not require the presence of packet- or circuit-switched networks.

The switch 130 and/or server 110 may be any architecture for directing contacts to one or more communication devices. In some embodiments, the switch 130 may perform load-balancing functions by allocating incoming or outgoing contacts among a plurality of logically and/or geographically distinct contact centers. Illustratively, the switch 130 and/or server 110 may be a modified form of the subscriber-premises equipment sold by Avaya Inc. under the names Definity™ Private-Branch Exchange (PBX) based ACD system, MultiVantage™ PBX, Communication Manager™, S8300™ media server and any other media servers, SIP Enabled Services™, Intelligent Presence Server™, and/or Avaya Interaction Center™, and any other products or solutions offered by Avaya or another company. Typically, the switch 130/server 110 is a stored-program-controlled system that conventionally includes interfaces to external communication links, a communications switching fabric, service circuits (e.g., tone generators, announcement circuits, etc.), memory for storing control programs and data, and a processor (i.e., a computer) for executing the stored control programs to control the interfaces and the fabric and to provide ACD functionality. Other types of known switches and servers are well known in the art and therefore not described in detail herein.

The first communication devices 134-1-N are packet-switched and may include, for example, IP hardphones such as the Avaya Inc.'s, 4600 Series IP Phones™, IP softphones such as Avaya Inc.'s, IP Softphone™, Personal Digital Assistants (PDAs), Personal Computers (PCs), laptops, packet-based H.320 video phones and conferencing units, packet-based voice messaging and response units, packet-based traditional computer telephony adjuncts, peer-to-peer based communication devices, and any other communication device.

The second communication devices 138-1-M are circuit-switched. Each of the communication devices 138-1-M corresponds to one of a set of internal extensions Ext1-M, respectively. The second communication devices 138-1-M may include, for example, wired and wireless telephones, PDAs, H.320 videophones and conferencing units, voice messaging and response units, traditional computer telephony adjuncts, and any other communication device.

It should be noted that the present invention does not require any particular type of information transport medium between switch, or server and first and second communication devices, i.e., the present invention may be implemented with any desired type of transport medium as well as combinations of different types of transport channels.

The packet-switched network 162 can be any data and/or distributed processing network, such as the Internet. The packet-switched network 162 typically includes proxies (not shown), registrars (not shown), and routers (not shown) for managing packet flows.

The packet-switched network 162 as shown in FIG. 1 is in communication with a first communication device 174 via a security gateway 178, and the circuit-switched network 152 with an external second communication device 180.

In a preferred configuration, the server 110, the packet-switched network 162, and the first communication devices 134-1-N are Session Initiation Protocol (SIP) compatible and can include interfaces for various other protocols such as the Lightweight Directory Access Protocol (LDAP), H.248, H.323, Simple Mail Transfer Protocol (SMTP), IMAP4, ISDN, E1/T1, and analog line or trunk.

It should be emphasized that the configuration of the switch 130, the server 110, user communication devices, and other elements as shown in FIG. 1 is for purposes of illustration only and should not be construed as limiting the invention to any particular arrangement of elements.

As will be appreciated, the server 110 is notified via the LAN 142 of an incoming work item by the communications component (e.g., switch 130, fax server, email server, web server, and/or other server) receiving the incoming work item as shown in FIG. 1. The incoming work item is held by the receiving telecommunications component until the server 110 forwards instructions to the component to forward or route the contact to a specific contact center resource, such as the IVR unit 122, the voice mail server 118, and/or first or second telecommunication device 134-1-N, 138-1-M associated with a selected agent. The server 110 distributes and connects these work items to telecommunication devices of available agents based on the predetermined criteria noted above. When the server 110 forwards a voice contact (or first work item) to an agent, the server 110 also forwards customer-related information from the database 114 to the agent's computer work station for viewing (such as by a pop-up display) to permit the agent to better serve the customer to achieve desired business goals (e.g., average revenue, customer satisfaction, service level agreement etc.). Depending on the contact center configuration and current status of the business goals, the server 110 may reallocate the work items to the agents. The agents process the work items or contacts sent to them by the server 110. This embodiment is particularly suited for a Customer Relationship Management (CRM) environment in which customers are permitted to use any media to contact a business. In a CRM environment, both real-time and non-real-time contacts must be handled and distributed with equal efficiency and effectiveness.

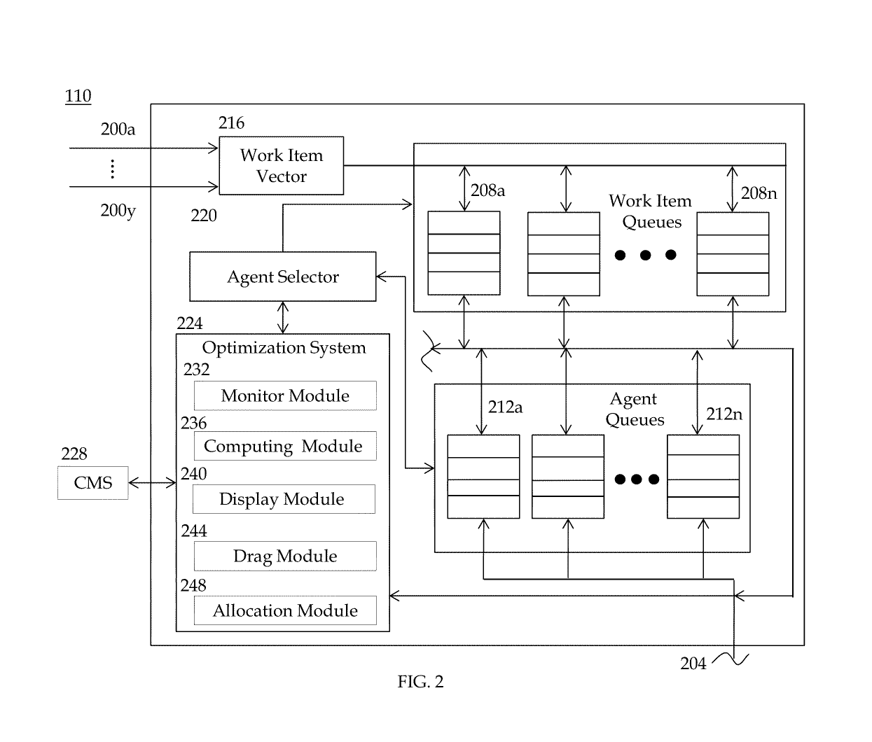

Referring to FIG. 2, one possible configuration of the server 110 is depicted. The server 110 is in communication with a plurality of customer communication lines 200a-y (which can be one or more trunks, phone lines, etc.) and agent communication line 204 (which can be a voice-and-data transmission line such as the LAN 142 and/or a circuit switched voice line). The server 110 can include Avaya Inc.'s an Operational Analyst™ (OA) with On-Line Analytical Processing (OLAP) technology or a Call Management System (CMS) 228 that gathers contact records and contact center statistics for use in generating visual feedbacks. OA and CMS will hereinafter be referred to jointly as CMS 228.

As can be seen in FIG. 2, included among the data stored in the server 110 is a set of contact or work item queues 208a-n and a separate set of agent queues 212a-n. Each contact queue 208a-n corresponds to a different set of agent queues, as does each agent queue 212a-n. Conventionally, contacts are prioritized and either is enqueued in individual ones of the contact queues 208a-n in their order of priority or is enqueued in different ones of a plurality of contact queues that correspond to a different priority. Likewise, each agent's queues are prioritized according to his or her level of expertise or skill in that queue, and either agents are enqueued in individual ones of agent queues 212a-n in their order of expertise level or are enqueued in different ones of a plurality of agent queues 212a-n that correspond to a queue and each one of which corresponds to a different expertise level.

Included among the control programs in the server 110 is a work item vector 216. Contacts incoming to the contact center are assigned by the work item vector 216 to different work item queues 208a-n based upon a number of predetermined criteria, including customer identity, customer needs, contact center needs, current contact center queue lengths, customer value, and the agent skill that is required for proper handling of the contact. Agents who are available for handling work items are assigned to agent queues 212a-n based upon the skills that they possess. An agent may have multiple skills, and hence may be assigned to multiple agent queues 212a-n simultaneously. Furthermore, an agent may have different levels of skill expertise (e.g., skill levels 1-N in one configuration or merely primary skill levels and secondary skill levels in another configuration), and hence may be assigned to different agent queues 212a-n at different expertise levels.

In one configuration, the contact center is operated by a contract operator, and each of the work item queues 208a-n, and possibly each of the agent queues 212a-n, corresponds to a different client. Each client can have a separate service level agreement or other type of performance measurement agreement with the contract operator regarding performance expectations, goals, requirements or specifications for the client's respective queue(s). The service level agreement can set forth penalties, such as financial penalties, for failing to comply with the service level agreement's requirements.

According to the present invention, included among the programs executing on the server 110 are an agent and work item selector 220 and an optimization system 224. The agent and work item selector 220 and the optimization system 224 are stored either in the main memory or in a peripheral memory (e.g., disk, CD ROM, etc.) or some other computer-readable medium of the contact center. The agent and work item selector 220 effects an assignment between available work items (or contacts) and available agents in a way that tends to maximize contact center business goals and efficiency for the current contact center state. The agent and work item selector 220 uses predefined criteria in selecting an appropriate agent to service the work item. The optimization system 224, in particular, obtains, for each of a plurality of contact center business goals or objectives, current status information, or information respecting whether or not a corresponding business goal (for example, the service level agreement) is being met or unmet and/or a level to which the corresponding goal is being met or unmet. For example, exemplary business goal levels can be expressed as actual, average or median wait times in each work item queue 208a-n, actual, average, or median agent staffing levels in each agent queue 212a-n, actual, average, or median revenue (whether gross or net) realized by a designated set of agents (such as the agents in an agent skill queue) per serviced contact, a customer satisfaction level for a set of designated agents determined during or after servicing of each customer's contact, actual, average, or median time for the agents in a set of designated agents to service contacts, number of contacts to be serviced by a set of designated agents during a selected time period, and the service level agreement between the contractor and the client. This information, along with other statistics is typically gathered by the CMS 228.

The agent and their associated data are maintained and updated by the database 114. Upon the completion of handling a work item, a generator collects selected metrics for the work item. These metrics include the skill involved in servicing the work item, the identifier of the servicing agent, the contact duration, the transaction or contact type (e.g., sale, information request, complaint, etc.), the time-of-day, the result (e.g., the type of sale, the number of units sold, average revenue generated etc.), a self-rating of the servicing agent respecting the agent's proficiency in handling the work item, the rating of the customer of the agent's proficiency in handling the work item, the rating of another party, such as the agent's supervisor or another observer, of how the work item was serviced, whether the agent requested assistance, and whether the agent's training was completed, and stores the information in the database 114, such as the CMS 228.

The optimization system 224 has to access to various details of incoming calls as well as details of the current status of the business goals in the contact center. The optimization system 224 also monitors the business goals having current operating values below than a threshold. The optimization system 224 may also generate a visual representation of business goals according to their operating status. The optimization system 224 may also enable a user (for example, a supervisor or manager of the contact center) to change current operating value of a business goal. The user may drag a graph or curve of a desired business goal to a desired operating value. Those skilled in the art will appreciate that since some business goals are interrelated and compete for same resources, so change in value of one business goal will affect value of competing business goals. The optimization system 224 may compute and display modifications in values of other business goals due to the change in the value of the business goal (done by the user). Further, in an embodiment of the present invention, if value of a business goal is below a predefined threshold value, the optimization system 224 may provide notifications to the supervisor of the contact center to take some immediate actions (e.g., reallocate agents to handle calls) to maintain the values of the business goals at desired operating values. The optimization system 224 may utilize a work assignment engine to manage the business goals at the desired values.

According to an embodiment of the present invention, the optimization system 224 includes a monitor module 232, a computing module 236, a display module 240, a drag module 244, and an allocation module 248.

The monitor module 232 may monitor current status of business goals of the contact center in an embodiment of the present invention. The monitor module 232 may monitor the current status of the business goals resulting from a current routing strategy of the work assignment based contact center. The business goals of the contact center may include an average revenue, a customer satisfaction, a service level agreement, or an agent training. For example, numerical values of the business goals may include a current average revenue value, number of available talking minutes based on available agents in the contact center etc. In another embodiment of the present invention, the monitor module 232 may monitor parameters of incoming calls that may increase values of the business goals for example, which service field or category (e.g., sales of health insurance) is generating more revenues, or contributes in increasing the business goals. For example, incoming calls related to general health insurance may result in increasing average revenue of the contact center. The monitor module 232 may store this information as the parameters of the calls in the database 114.

Further, the monitor module 232 may monitor details of agents specialized in handling the calls to generate more revenues from the incoming calls. Further, the monitor module 232 is configured to receive values of desired business goals from the supervisor or a manager or an administrator. In case, if the supervisor wants to change or optimize the value of a business goal to a desired value. The inputs provided by the supervisor may be received by the computing module 236 (explained below). In one embodiment of the present invention, monitoring of the current status of the business goals is carried out in a real time environment.

The computing module 236 is configured to compute values of competing business goals of the contact center in an embodiment of the present invention. The values of the competing business goals may be computed based on the monitored status (e.g., routing strategy) of the business goals. For example, if average revenue of the contact center is $20, then the computing module 236 may compute values of other competing business goals (e.g., the customer satisfaction, the service level agreement etc.). The computing module 236 is also configured to automatically compute values of the business goals that may help the supervisor to achieve desired business goal values (i.e., suggested values of the business goal to keep all of them within acceptable level) and also to manage resources (e.g., allocating agents for handling calls) of the contact center.

The computing module 236 is further configured to generate visual or graphical representation for the computed values of the competing business goals in an embodiment of the present invention. The visual representation may include pie charts, bar charts, line charts, histograms etc. The visual representation of the competing business goals may be two dimensional (2D) or three dimensional (3D). Further, adjustable sectors of the visual representation may represent parameters for example, available “talk minutes” of the contact center which is derived from the number of agents present in the contact center.

In another embodiment of the present invention, the computing module 236 may also generate numerical values for the competing business goals of the contact center. Further, the computing module 236 may determine the business goals having current operating values below than a threshold in an embodiment of the present invention.

The display module 240 displays the generated visual representation for the computed values of the competing business goals in an embodiment of the present invention. The displayed visual representation displays the current status of the business goals based on the current routing strategy of the work assignment based contact center. In another embodiment of the present invention, the display module 240 may display the generated modified visual representation based on the computed values of the business goals of the contact center. The display module 240 may display the modified values of the business goals in different colors in the visual representation in an embodiment of the present invention. For example, if average revenue of the contact center is increased based on the change in values of the business goals, then the display module 240 may display an increased coloration towards the axis of the visual representation that indicates reallocation of the resources in the contact center. Also, the different colors may represent different skills of the resources such as blue color may represent dual-skilled agents, green color may represent single-skilled agents (e.g., sales agents) etc. in an embodiment of the present invention.

Further, in yet another embodiment of the present invention, the display module 240 may generate alerts and display notifications to the supervisor if values of the business goals deteriorates or is below a threshold level. The display module 240 is configured to generate a plurality of alerts comprising beeps, flash, and popup. Further, the display module 240 may display immediate visual feedback of the resource usage required while maintaining the competing business goals of the contact center. For example, while monitoring the visual representation of agent training with a desired business goal of increasing the customer satisfaction, a caller (or customer) of an incoming call is involved in a legal obligation and need information about a health insurance that is handled by an agent who is trained up to a certain standard by a certain time. Then this may be represented as an alert in the form of a red line in the visual representation. Also, if the agent is trying to alter other competing business goals (e.g., increasing average revenue) then an alert is flashed on the supervisor's screen. This alert may notify the supervisor that a business goal (i.e., agent training) is being compromised and also a contract or an agreement or government statuary obligation is being impeached. Therefore, the displayed visual representation may help the supervisor to identify both inefficiencies and opportunities for the contact center.

Further, the drag module 244 enables the supervisor to change values of the business goals of the contact center. In an embodiment of the present invention, the drag module 244 may enable the supervisor to drag or pull shape (i.e., graph or curve) of the visual representation of the business goals to change the values of the business goals. For example, the supervisor of the contact center may change the values of the business goals by dragging or pulling the shape of the business goal to a desired value of the business goal. The changed or modified values of the business goals are stored in the database 114.

Further, the drag module 244 enables the supervisor to change allocation of resources of the contact center in an embodiment of the present invention. The drag module 244 may enable the supervisor to drag or pull additional resources of the contact center along the axis of a particular business goal in the visual representation to view relative impact on the associated business goals. For example, the supervisor clicks and drags “sales resources” (i.e., agents having good sales skills) towards and along an axis of the visual representation that represents the business goal customer satisfaction, then anticipated customer satisfaction business goal increases in a small amount in proportion to the change in the resource allocation. But, there is a significant impact on values of the associated business goals such as average revenue for which the anticipated reduction is quite large. After analyzing the visual representation, the supervisor may reset all the changes and then tries again. Now, the supervisor drags general resources of the contact center towards and along an agent training axis. There are some health insurance sales agents that may be suitable for training of the resources for out-of-state sales of the health insurance. Once the resources have completed the training, they are legally permitted to sell the health insurance in other states that may improve the average revenue of the contact center. This change may affect the service level agreement of the contact center for a particular time (e.g., during training) but may improve the average revenue. Therefore, the supervisor may then accept this change in the visual representation. Further, based on the changes, the drag module 244 may also display the anticipated performance or end-state of the resources with an increased coloration of the graph area representing multi-skilled agents and improvement along the average revenue axis.

The drag module 244 is further configured to compute modified values of the competing business goals based on the changed values of the business goals provided by the supervisor. For example, if value of the average revenue is changed from $20 to $90, then the drag module 244 may compute modified values of other competing business goals based on the desired or changed value of the business goal (i.e., average revenue). Further, the drag module 244 may also generate a modified visual representation for the values of the competing business goals that is computed based on the inputs (e.g., altered value of the average revenue $90) provided by the supervisor.

Further, in an embodiment of the present invention, the drag module 244 may provide suggested value of the business goal to the supervisor so as to keep other business goals within their thresholds. The drag module 244 may prompt the supervisor to approve the suggested value. In another embodiment of the present invention, the drag module 244 may automatically optimize values of the competing business goals of the contact center to achieve desired values of the competing business goals. The drag module 244 retrieves or utilizes stored values of the business goals from various locations for example, configuration of the contact center, information stored in the databases, supervisor's end system, ordering or purchasing systems, marketing information stored in the database 114 based on the customer satisfaction results, correlation between good or bad customer satisfaction feedback from various skilled set agent proficiencies, or service level agreement historical reporting data in the contact center, incoming calls, expected work load that what resources are expected to be busy and at what time, average revenue stored in the database 114 of the contact center etc.

The allocation module 248 may suggest and allocate resources based on the displayed modified visual representation. In an embodiment of the present invention, the allocation module 248 may ask the supervisor to approve the suggested allocation. For example, if the visual representation indicates that if an agent talks to a customer for three minutes it may lead to a sale of product (e.g., general health insurance policy) which results in an increase in the average revenue of the contact center, then the allocation module 248 (or supervisor) may increase the handling time of that skill and may allocate more agents to handle those calls. In another embodiment of the present invention, the allocation module 248 may automatically manage the resources of the contact center by routing calls to the skilled agents to achieve desired values of the business goals. The routing strategy is based on the priority of the business goals that is provided by the supervisor. The incoming calls are being routed by the allocation module 248 to the resources by using a predefined routing algorithm.

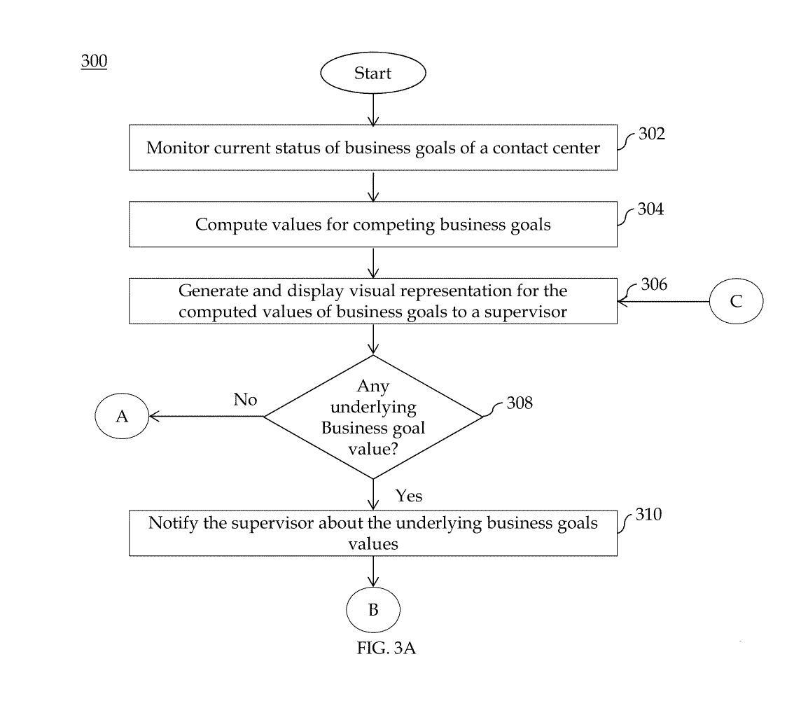

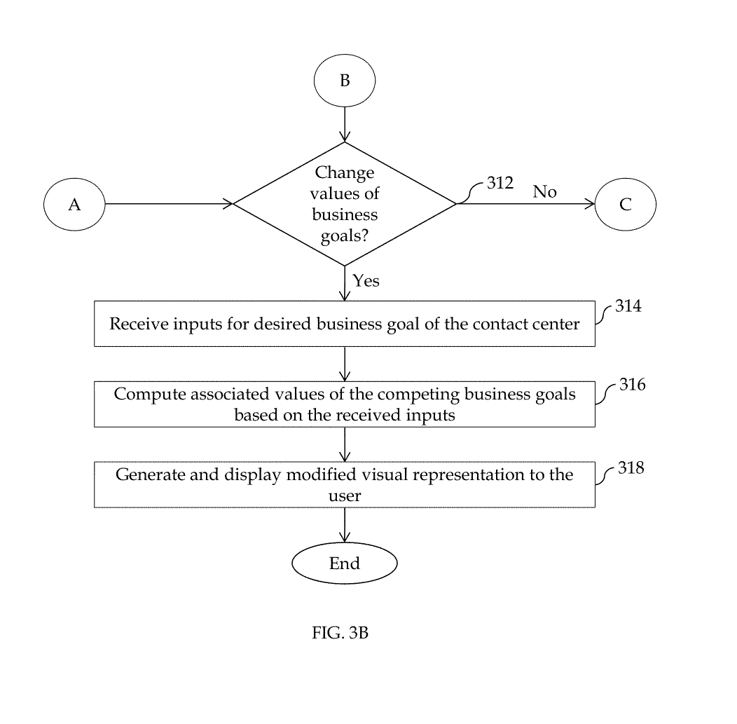

FIGS. 3A and 3B depict a flowchart of a method for generating a visual representation of status of business goals according to an embodiment of the present invention.

At step 302, an optimization system 224 may monitor current status of the business goals of a contact center. In an embodiment of the present invention, the business goals of the contact center may include average revenue, a customer satisfaction, an agent training, or a service level agreement. The current status of the business goals may include current values of the business goals resulting from existing routing strategy of the work assignment based contact center.

At step 304, the optimization system 224 may compute values for competing business goals of the contact center, in an embodiment of the present invention. The values of the competing business goals is computed based on the monitored status (e.g., existing routing strategy) of the business goals in the contact center. For example, the optimization system 224 may compute values of the competing business goals (e.g., customer satisfaction, service level agreement etc.) based on the monitored status of the business goals. The values of the business goals are computed in the following units such as the average revenue may be displayed in dollars ($), the service level agreement may be indicated in minutes or seconds that shows how long it takes to answer a call, the level of agent trainee may be indicated as a trainee, a middle, a competent, an expert, a super etc., and the customer satisfaction may be displayed in percentage based on the number of customers in last survey. The optimization system 224 may then access the contact center configuration or databases to retrieve information (e.g., from where the sales come from). Based on the retrieved information, the optimization system 224 then compute the values of the competing business goals of the contact center.

At step 306, the optimization system 224 may generate a visual representation for the computed business goals of the contact center. In an embodiment of the present invention, the visual representation may include pie charts, bar charts, line charts, histograms etc. The visual representation of the competing business goals may be two dimensional (2D) or three dimensional (3D). Further, adjustable sectors of the visual representation may represent parameters for example, available “talk minutes” of the contact center which is derived from the number of agents present in the contact center. In another embodiment of the present invention, the optimization system 224 may also generate numerical values for the competing business goals of the contact center.

In yet another embodiment of the present invention, the generated visual representation is displayed based on the current status of the business goals resulting from current routing strategy of the work assignment based contact center. Further, the generated visual representation based on the computed values of the business goals is displayed in an embodiment of the present invention.

At step 308, the optimization system 224 may determine whether any value of the business goals is below a threshold level. If the values of the business goals are greater than a threshold value then the method proceeds towards step 312. Otherwise, the method proceeds towards step 310.

At step 310, the optimization system 224 may notify the supervisor about the business goals having current operating values below than a predefined threshold value to take immediate actions. The actions may include managing resources of the contact center such as allocating resources based on the displayed shape of the visual representation.

At step 312, the optimization system 224 may enable the supervisor to optimize or change the value of the business goals to a desired operating value. In case, if the supervisor does not desire to change the operating values of the business goals, then the optimization system 224 may continue to display the generated visual representation. In case, if the optimization system 224 determines that the supervisor desires to change the operating values of the business goals, then the method proceeds towards step 314.

At step 314, the optimization system 224 may receive inputs (e.g., desired values of the business goals) from the supervisor of the contact center, in an embodiment of the present invention. The optimization system 224 may enable the supervisor to drag or pull shape of the displayed business goal to a desired operating value in the visual representation. For example, the supervisor may drag or pull the outer boundary of the average revenue outwards to increase the value of the average revenue from $20 to $90.

At step 316, the optimization system 224 may compute associated values of the competing business goals based on the received inputs in an embodiment of the present invention. The competing business goals of the contact center may include the customer satisfaction, the service level agreement, the agent training etc. In another embodiment of the present invention, the optimization system 224 may retrieve or utilize stored values of the business goals from various locations for example, configuration of the contact center, information stored in the databases, supervisor's end system, ordering or purchasing systems, marketing information stored in the database based on the customer satisfaction results, correlation between good or bad customer satisfaction feedback from various skilled set agent proficiencies, or service level agreement historical reporting data in the contact center, incoming calls, expected work load that what resources are expected to be busy and at what time, average revenue stored in the database of the contact center etc.

At step 318, the optimization system 224 may generate a modified visual representation for the computed business goals of the contact center. In an embodiment of the present invention, the visual representation may include pie charts, bar charts, line charts, histograms etc. The visual representation of the competing business goals may be two dimensional (2D) or three dimensional (3D). For example, adjustable sectors of the two dimensional visual representation may represent parameters for example, available talk minutes of the contact center which is derived from the number of agents present in the contact center. Further, in case of the three dimensional visual representation the third axis may represent proficiency of the agents in a specific field. Therefore, by rotating the three dimensional representation of the resources, the supervisor may observe the limits or the level of training the agents may have on the attainment of the business goals. In yet another embodiment of the present invention, the optimization system 224 may also display numerical values for the competing business goals of the contact center.

In another embodiment of the present invention, the generated visual representation is displayed based on the inputs received from the supervisor of the contact center. Further, the generated visual representation based on the computed values of the business goals is displayed in an embodiment of the present invention.

In another embodiment of the present invention, the optimization system 224 may further inform the supervisor to manage the resources based on the displayed shape of the visual representation in an embodiment of the present invention. For example, if the shape of the visual representation indicates that if an agent talks to a customer for three minutes it leads to a sale of product (e.g., general health insurance policy) which results in an increase in the average revenue of the contact center, then the supervisor increases handling time of that skill and allocates more agents to handle those incoming calls.

In another embodiment of the present invention, the optimization system 224 may automatically advise the supervisor to manage the resources of the contact center by routing some specific calls to some specific agents (e.g., skilled agents). The routing strategy is based on the priority of the business goals that is provided by the supervisor. The incoming calls are then routed by the optimization system 224 to the skilled agents by using a predefined routing algorithm.

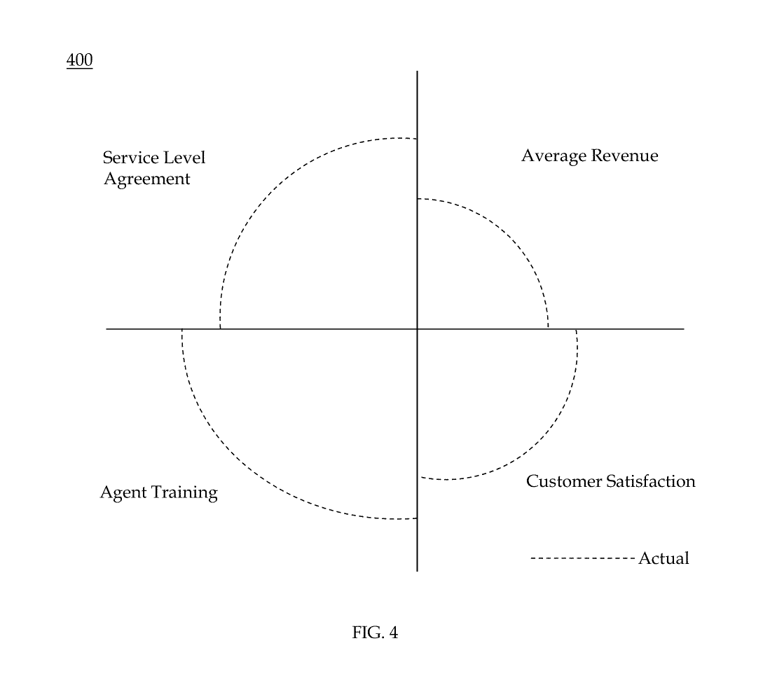

FIG. 4 illustrates a visual representation of monitored values of business goals of a contact center according to an embodiment of the present invention. The optimization system 224 may display the illustrated visual representation of the monitored values of the business goals based on an existing routing strategy or resource set. A supervisor of the contact center may monitor the existing values or levels of meeting the business goals. Further, the supervisor may visualize that on which value of a business goal, the supervisor often end up having to make trade-offs and compromises in real time with the available resources. As shown in FIG. 4, the average revenue of the contact center is being compromised while other competing business goals such as the customer satisfaction, the service level agreement etc. are at desired levels. Based on the displayed visual representation, the supervisor may make necessary changes in meeting the objectives of the contact center. In another embodiment of the present invention, a visual representation may have a number of spokes representing multiple business goals in a pie chart.

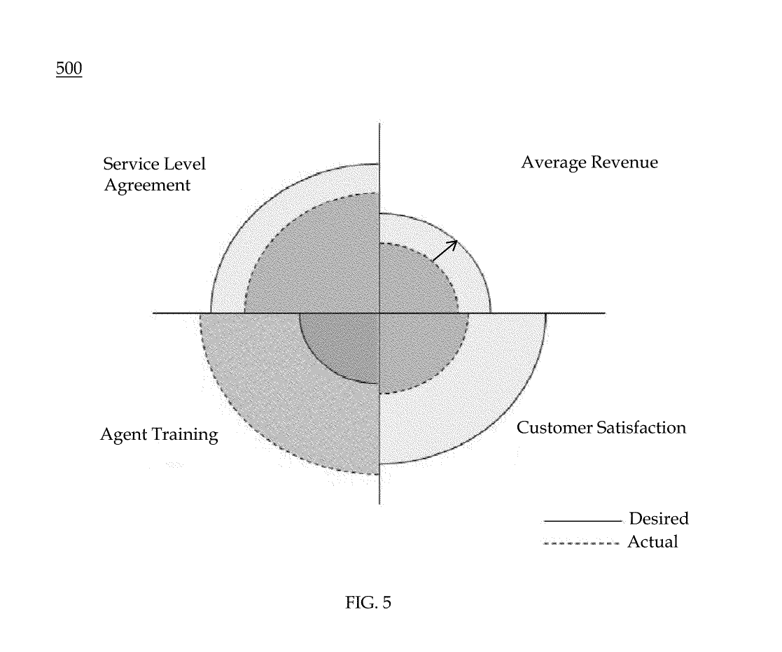

FIG. 5 illustrates a visual representation of modification in competing business goals due to change in value of one business goal of a contact center according to an embodiment of the present. From the displayed visual representation, the supervisor of the contact center may observe a way in which resource allocation is being facilitated, and where relative impact of the resource allocation of one business goal on other competing business goals is also observable. As shown in FIG. 5, the dotted lines represent the actual and monitored values of the business goals of the contact center while the desired values of the business goals are represented by solid lines. For example, if the objective of the contact center is to increase the average revenue from $20 to $90, then the supervisor of the contact center may change the value of the average revenue by dragging or pulling shape of the average revenue outwards to increase the average revenue in the visual representation. The optimization system 224 may then compute values of the associated competing business goals and generate the visual representation based on the computed values of the business goals. The optimization system 224 may compute the values of the competing business goals by retrieving and utilizing values from contact center configuration, information stored in the databases, supervisor's end system, ordering or purchasing systems, marketing information stored in the database 114 based on the customer satisfaction results, correlation between good or bad customer satisfaction feedback from various skilled set agent proficiencies, or service level agreement historical reporting data in the contact center, incoming calls, expected work load that what resources are expected to be busy and at what time, average revenue stored in the database of the contact center etc. Based on the shape of the visual representation, the supervisor may then prioritize agents with high proficiencies in sales of the contact center to handle the calls related to sales which are one of an important factor to increase the sales and average revenue of the contact center.

In this case, the main objective of the contact center is to increase the average revenue per call, by increasing the target talk time of the agents. However, this is at the expense of compensating the business goal of low service level agreement, as the contact center handles other calls that are less associated with revenue and from which some resources have been removed. The displayed shape of the visual representation also shows a non-linear impact on the usage of less experienced agents (e.g., trainees, middle etc.) and therefore, the objective to train these agents is affected. The effects on the competing business goals (e.g., the service level agreement, the agent training, the customer satisfaction etc.) are assessed and displayed to the supervisor who can now easily decide on balancing factors between the business goals by using the shape of the visual representation. Further, the supervisor may drag or pull the outline or shape of the service level agreement outwards in order to maintain the level of the service level agreement, and the displayed visual representation may result in increasing the routing of agents to handle the incoming calls that may improve the values of the service level agreement.

The exemplary systems and methods of this present invention have been described in relation to a user device (e.g., smart device). However, to avoid unnecessarily obscuring the present invention, the preceding description omits a number of known structures and devices. This omission is not to be construed as a limitation of the scope of the present invention. Specific details are set forth to provide an understanding of the present invention. It should however be appreciated that the present invention may be practiced in a variety of ways beyond the specific detail set forth herein.

Furthermore, while the exemplary embodiments of the present invention illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices, such as a switch, server, and/or adjunct, or collocated on a particular node of a distributed network, such as an analog and/or digital telecommunications network, a packet-switch network, or a circuit-switched network.

It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the present invention.

A number of variations and modifications of the present invention can be used. It would be possible to provide for some features of the present invention without providing others.

For example in one alternative embodiment of the present invention, the systems and methods of this present invention can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like.

In general, any device(s) or means capable of implementing the methodology illustrated herein can be used to implement the various aspects of this present invention. Exemplary hardware that can be used for the present invention includes computers, handheld devices, telephones (e.g., cellular, Internet enabled, digital, analog, hybrids, and others), and other hardware known in the art. Some of these devices include processors (e.g., a single or multiple microprocessors), memory, non-volatile storage, input devices, and output devices. Furthermore, alternative software implementations including, but not limited to, distributed processing or component/object distributed processing, parallel processing, or virtual machine processing can also be constructed to implement the methods described herein.

In yet another embodiment of the present invention, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this present invention is dependent on the speed and/or efficiency requirements of the system, the particular function, and the particular software or hardware systems or microprocessor or microcomputer systems being utilized.

In yet another embodiment of the present invention, the disclosed methods may be partially implemented in software that can be stored on a storage medium, executed on programmed general-purpose computer with the cooperation of a controller and memory, a special purpose computer, a microprocessor, or the like. In these instances, the systems and methods of this present invention can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present invention describes components and functions implemented in the embodiments with reference to particular standards and protocols, the present invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, sub-combinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and/or reducing cost of implementation.

The foregoing discussion of the present invention has been presented for purposes of illustration and description. The foregoing is not intended to limit the present invention to the form or forms disclosed herein. In the foregoing Detailed Description for example, various features of the present invention are grouped together in one or more embodiments, configurations, or aspects for the purpose of streamlining the disclosure. The features of the embodiments, configurations, or aspects of the present invention may be combined in alternate embodiments, configurations, or aspects other than those discussed above. This method of disclosure is not to be interpreted as reflecting an intention that the present invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the present invention.

Moreover, though the description of the present invention has included description of one or more embodiments, configurations, or aspects and certain variations and modifications, other variations, combinations, and modifications are within the scope of the present invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. An optimization system for generating a visual representation of business goals in a contact center, the optimization system comprising:
a monitor module configured to monitor current status of the business goals of the contact center;
a computing module configured to compute values of the business goals and generate the visual representation;
a drag module configured to enable a user to change value of a business goal from an actual operating value to a desired operating value; and
a display module configured to display modification in values of associated business goals due to the change in the value of the business goal.

2. The optimization system of claim 1, wherein the business goals comprises an average revenue, a service level agreement, a customer satisfaction, and an agent training.

3. The optimization system of claim 1, wherein the visual representation comprises pie charts, bar charts, line charts, and histograms.

4. The optimization system of claim 1, wherein the visual representation is one of a two dimensional or a three dimensional.

5. The optimization system of claim 1, wherein the current status of the business goals comprises values of the business goals resulting from current routing rules.

6. The optimization system of claim 1, wherein the display module is further configured to display numerical values of the business goals.

7. The optimization system of claim 1, wherein the computing module is further configured to determine business goals having current operating values below than a predefined threshold.

8. The optimization system of claim 7, wherein the display module is further configured to notify a user about the business goals having current operating value below than the threshold.

9. The optimization system of claim 1, wherein the drag module is further configured to enable the user to change the values of the business goals by dragging graph of the business goals in the visual representation.

10. The optimization system of claim 1, further comprising an allocation module configured to manage resources based on the generated modified visual representation.

11. The optimization system of claim 1, wherein the allocation module is further configured to suggest allocation of resources to achieve desired operating values of the business goals.

12. A computer-implemented method for generating a visual representation of business goals in a contact center, the method comprising:
monitoring current status of the business goals of the contact center;
computing values for the business goals of the contact center based on the monitored status of the business goals;
generating the visual representation of the business goal based on the computed values;
enabling a user to change value of a business goal from an actual operating value to a desired operating value in the visual representation; and
displaying modification in values of associated business goals due to the change in the value of the business goal.

13. The computer-implemented method of claim 12, wherein the business goals comprises an average revenue, a service level agreement, a customer satisfaction, and an agent training.

14. The computer-implemented method of claim 12, wherein the visual representation comprises pie charts, bar charts, line charts, and histograms.

15. The computer-implemented method of claim 12, wherein the current status of the business goals comprises values of the business goals resulting from current routing rules.

16. The computer-implemented method of claim 12, further comprising determining business goals having current operating values below than a predefined threshold.

17. The computer-implemented method of claim 16, further comprising notifying a user about the business goals having current operating values below than the predefined threshold.

18. The computer-implemented method of claim 12, wherein the competing business goals are computed by utilizing values from a contact center configuration, a service level agreement historical reporting data, a customer satisfaction feedback from various skilled set agent proficiencies, and an average revenue stored in a database.

19. The computer-implemented method of claim 12, further comprising managing resources to handle calls based on the generated modified visual representation.

20. A computer-implemented method for generating a visual representation of desired business goals in a contact center, the method comprising:
monitoring current status of the business goals of the contact center;
computing values for the business goals of the contact center based on the monitored status of the business goals;
generating the visual representation of the business goals based on the computed values;
receiving a user input for a desired value of a business goal of the contact center;
computing modification in values of associated business goals of the contact center based on the received input;
generating a modified visual representation of the business goal and associated business goals based on the modified values of the competing business goals; and
displaying the modified values of the business goal and associated business goals in the generated modified visual representation.
